(19) United States
(12) Patent Application Publication
(10) Pub. No.: US 2023/0349397 A1
(43) Pub. Date: Nov. 2, 2023

(54) HYDRAULIC SYSTEM

(71) Applicant: Dana Motion Systems Italia S.r.l., Reggio Emilia (IT)

(72) Inventors: Stefano FASANO, Reggio Emilia (IT); Daniele DODI, Reggio Emilia (IT); Bartoli MAURIZIO, Reggio Emilia (IT); Alessandro SASSI, Reggio Emilia (IT)

(73) Assignee: Dana Motion Systems Italia S.r.l., Reggio Emilia (IT)

(21) Appl. No.: 18/305,600

(22) Filed: Apr. 24, 2023

(30) Foreign Application Priority Data
Apr. 29, 2022 (DE) 20 2022 102 319.0

(51) Int. Cl. F15B 11/17; F15B 13/02

(52) U.S. Cl. CPC F15B 11/17; F15B 13/026; F15B 2211/20576

(57) ABSTRACT

The present document relates to a hydraulic system having a first hydraulic pump, a second hydraulic pump, at least one hydraulic actuator, a low-pressure tank, and a pressure controlled flow compensating valve. A high-pressure port of the first hydraulic pump and a high-pressure port of the second hydraulic pump are fluidly connected or fluidly connectable to the at least one hydraulic actuator. The high-pressure port of the second hydraulic pump is selectively fluidly connectable to the low-pressure tank via the flow compensating valve. The flow compensating valve is controllable by or based on one or more of: a hydraulic pressure provided by the first hydraulic pump, a hydraulic pressure provided by the second hydraulic pump, and a hydraulic pressure at a fluid port of the at least one hydraulic actuator.

### FIELD

The present disclosure relates to hydraulic systems comprising hydraulic pumps providing a flow of hydraulic fluid under high pressure, for example to actuators with a variable load.

### BACKGROUND

Such kinds of hydraulic systems are widely known in the art. For example, US9458864B2 discloses a hydraulic drive circuit including a main hydraulic pump, an actuator driven by high pressure fluid delivered by the main hydraulic pump, and an additional hydraulic pump for increasing the pressure and volume of the delivered fluid.

US9145905B2 discloses a hydraulic system including two load sensing hydraulic pumps responding independently to a load. US9194107B2 discloses a hydraulic system including several hydraulic pumps fixedly coupled to one another.

US10280592B2 discloses a hydraulic system including a hydraulic pump and an energy storage device. When high pressure is required, the flow rate of the pump is limited by a control device in order to limit power consumption of the pump and in order to provide a reasonable use of the storage device.

### SUMMARY

Against the background of the prior art, the presently proposed subject matter addresses the problem of providing a hydraulic system which is capable of delivering hydraulic energy to an actuator in an efficient manner and which can be produced at low cost.

This objective is achieved by a hydraulic system including the features of the claims. Special embodiments are described in the dependent claims.

The presently proposed hydraulic system comprises a first hydraulic pump, a second hydraulic pump, at least one hydraulic actuator, a low-pressure tank, and a pressure controlled flow compensating valve,
wherein a high-pressure port of the first hydraulic pump and a high-pressure port of the second hydraulic pump are fluidly connected or fluidly connectable to the at least one hydraulic actuator,
wherein the high-pressure port of the second hydraulic pump is selectively fluidly connectable to the low-pressure tank via the flow compensating valve, and
wherein the flow compensating valve is controllable by or based on one or more of: a hydraulic pressure provided by the first hydraulic pump, a hydraulic pressure provided by the second hydraulic pump, and a hydraulic pressure at a fluid port of the at least one hydraulic actuator.

In other words the flow compensating valve may be controllable by or based on one of: a hydraulic pressure provided by one or both of the first hydraulic pump and the second hydraulic pump; a hydraulic pressure at a fluid port of the at least one hydraulic actuator; or a hydraulic pressure provided by one or both of the first hydraulic pump and the second hydraulic pump and a hydraulic pressure at a fluid port of the at least one hydraulic actuator.

The second hydraulic pump may complement the first hydraulic pump so that the first hydraulic pump and the second hydraulic pump may deliver a hydraulic flow and/or a hydraulic pressure to the at least one hydraulic actuator in a stable and efficient manner. For example, when the high-pressure port of the second hydraulic pump is fluidly connected to the low-pressure tank via the flow compensating valve, energy consumption of the second hydraulic pump may be significantly reduced. In some embodiments, the hydraulic system may comprise a pressure sensor configured to measure the hydraulic pressure at the high-pressure port of the second hydraulic pump and a controller. For instance, when the pressure sensor determines that a hydraulic pressure at the high-pressure port of the second hydraulic pump is below a threshold pressure, the controller may switch of the second hydraulic pump.

The first hydraulic pump and the second hydraulic pump may be fluidly connected or fluidly connectable to the at least one hydraulic actuator in parallel so that a flow and/or pressure provided to the at least one hydraulic actuator by the second hydraulic pump may complement a flow and/or pressure provided to the at least one hydraulic actuator by the first hydraulic pump, or vice versa.

A piloting port of the flow compensating valve, for example a first piloting port of the flow compensating valve, may be fluidly connected or fluidly connectable to the high-pressure port of the first hydraulic pump and/or to the high-pressure port of the second hydraulic pump. In this case, a hydraulic pressure delivered by the first hydraulic pump and/or by the second hydraulic pump may be used to control the flow compensating valve.

The flow compensating valve may be configured such that a hydraulic pressure applied to the first piloting port of the flow compensating valve biases the flow compensating valve to an open position in which the flow compensating valve fluidly connects the high-pressure port of the second hydraulic pump to the low-pressure tank.

The first piloting port of the flow compensating valve may be fluidly connected or fluidly connectable to the high-pressure port of the first hydraulic pump and/or to the high-pressure port of second hydraulic pump via at least one check valve. For example, the high-pressure port of the first hydraulic pump may be fluidly connectable to the first piloting port of the flow compensating valve via a first check valve, and the high-pressure port of the second hydraulic pump may be fluidly connectable to the first piloting port of the flow compensating valve via a second check valve. Specifically, the first check valve may be configured to allow a flow of fluid from the high-pressure port of the first hydraulic pump toward the first piloting port of the flow compensating valve through the first check valve, and to block a flow of fluid from the first piloting port of the flow compensating valve toward the high-pressure port of the first hydraulic pump through the first check valve. Similarly, the second check valve may be configured to allow a flow of fluid from the high-pressure port of the second hydraulic pump toward the first piloting port of the flow compensating valve through the second check valve, and to block a flow of fluid from the first piloting port of the flow compensating valve toward the high-pressure port of the second hydraulic pump through the second check valve. In this case, the check valves may guarantee that the higher pressure of the pressure values delivered by the first hydraulic pump and by the second hydraulic pump is used to control the flow compensating valve. Further, a flow of hydraulic fluid from the first hydraulic pump to the second hydraulic pump or vice versa can be avoided.

Alternatively, the first piloting port of the flow compensating valve may be fluidly connected or fluidly connectable to the high-pressure ports of the first hydraulic pump and of the second hydraulic pump via a shuttle valve.

The first hydraulic pump may be a load sensing pump. That is, a hydraulic displacement of the first hydraulic pump may be controllable via a hydraulic pressure applied to a load sensing port of the first hydraulic pump. The load sensing port of the first hydraulic pump may be fluidly connected or fluidly connectable to at least one fluid port of the at least one hydraulic actuator, for example via a load sensing line. A load sensing hydraulic pressure acting on or applied to the load sensing port of the first hydraulic pump may be indicative of the current load of the at least one hydraulic actuator. In one possible implementation of the proposed hydraulic system, for example in a closed center system, the first hydraulic pump may include a swash plate and an inclination of the swash plate of the first hydraulic pump may be controllable by or based on the load sensing hydraulic pressure acting on or applied to the load sensing port of the first hydraulic pump. For example, the first hydraulic pump may be configured such that a hydraulic pressure at the load sensing port of the first hydraulic pump biases the hydraulic displacement of the first hydraulic pump to increase or toward a larger hydraulic displacement. The load sensing port of the first hydraulic pump may be fluidly connected or fluidly connectable to the load sensing line via a first load sensing control valve. The load sensing functionality of the first hydraulic pump may then be selectively turned on or off. The second hydraulic pump may be or may include a fixed displacement pump.

The load sensing line may be fluidly connectable to a first fluid port of the at least one hydraulic actuator and to a second fluid port of the at least one hydraulic actuator via a shuttle valve. In particular, the shuttle valve may be configured to select a maximum hydraulic pressure of or between a hydraulic pressure at the first fluid port of the hydraulic actuator and a hydraulic pressure at the second fluid port of the hydraulic actuator.

A piloting port of the flow compensating valve, for example a second piloting port of the flow compensating valve, may be fluidly connected or fluidly connectable to the load sensing line and/or to at least one fluid port of the at least one hydraulic actuator. For example, the second piloting port of the flow compensating valve may be selectively fluidly connectable to the fluid port of the at least one hydraulic actuator and/or to the load sensing line via a second load sensing control valve. In this way, the second piloting port of the flow compensating valve may be selectively decoupled from a hydraulic pressure at the fluid port of the hydraulic actuator and/or from a hydraulic pressure in the load sensing line. For instance, by fluidly disconnecting the second piloting port of the flow compensating valve from the load sensing line, the position of the flow compensating valve may be controllable exclusively via the first hydraulic pump and/or via the second hydraulic pump and possibly by means of the biasing member of the flow compensating valve.

The flow compensating valve may be configured such that a hydraulic pressure applied to the second piloting port of the flow compensating valve biases the flow compensating valve to a closed position in which the flow compensating valve fluidly disconnects the high-pressure port of the second hydraulic pump from the low-pressure tank.

The balance of pressures and/or forces acting on the first piloting port of the flow compensating valve and on the second piloting port of the flow compensating valve may influence or determine whether the flow compensating valve is switched to the open position or to the closed position. For instance, the flow compensating valve may be configured such that when a relation between a hydraulic pressure applied to the first piloting port of the flow compensating valve and a hydraulic pressure applied to the second piloting port of the flow compensating valve is below a first predetermined threshold pressure, the flow compensating valve is switched to the closed position. Similarly, the flow compensating valve may be configured such that when a relation between a hydraulic pressure applied to the first piloting port of the flow compensating valve and a hydraulic pressure applied to the second piloting port of the flow compensating valve is above a second predetermined threshold pressure, the flow compensating valve is switched to the open position. The first predetermined threshold pressure is then typically equal to or smaller than the second predetermined threshold pressure.

The flow compensating valve may include a biasing member such as a spring. The biasing member may bias the flow compensating valve to a closed position in which the flow compensating valve fluidly disconnects the high-pressure port of the second hydraulic pump from the low-pressure tank, or to an open position in which the flow compensating valve fluidly connects the high-pressure port of the second hydraulic pump to the low-pressure tank.

The flow compensating valve may be controllable by a flow rate requested or demanded by the at least one hydraulic actuator. For example, an increasing hydraulic pressure at a fluid port of the at least one hydraulic actuator may indicate that the hydraulic actuator demands a higher flow rate. A deacreasing pressure at the same fluid port of the hydraulic actuator may result in the flow compensating valve connecting the high-pressure port of the second hydraulic pump to the low-pressure tank, thereby decreasing a flow rate from the second hydraulic pump to the hydraulic actuator. For instance, when a hydraulic pressure in the load sensing line representing the flow rate requested or demanded by the hydraulic actuator increases again, the flow compensating valve may fluidly disconnect the high-pressure port of the second hydraulic pump from the low-pressure tank, thereby increasing a flow rate provided to the hydraulic actuator.

The hydraulic system may comprise a control valve. The the high-pressure port of the first hydraulic pump and/or the high-pressure port of the second hydraulic pump may then be selectively fluidly connectable to the at least one hydraulic actuator via the control valve. The control valve may be a directional control valve. In this way, the high-pressure port of the first hydraulic pump and/or the high-pressure port of the second hydraulic pump may be selectively fluidly connectable with different fluid ports of the at least one hydraulic actuator. For example, if the at least one hydraulic actuator comprises a hydraulic cylinder, a directional control valve may be used to selectively apply a hydraulic pressure provided by the first hydraulic pump and/or by the second hydraulic pump to either a first fluid port of the hydraulic cylinder, thereby biasing a hydraulic piston in a first direction along the cylinder axis, or to a second fluid port of the hydraulic cylinder, thereby biasing the hydraulic piston in a second direction along the cylinder axis, opposite the first direction. Additionally or alternatively, the control valve may be configured to fluidly connect the at least one hydraulic actuator to the low-pressure tank. The load sensing line may be fluidly connected to a fluid line which fluidly connects the control valve to the at least one hydraulic actuator.

### DESCRIPTION OF THE FIGURES

Embodiments of the presently proposed hydraulic system are described in the following detailed description and are depicted in the accompanying drawing. In the figures

FIG. 1 schematically shows a hydraulic system with two pumps, a flow compensating valve and two actuators according to a first embodiment, and

FIG. 2 schematically shows a hydraulic system with two pumps, a flow compensating valve and two actuators according to a second embodiment.

### DETAILED DESCRIPTION

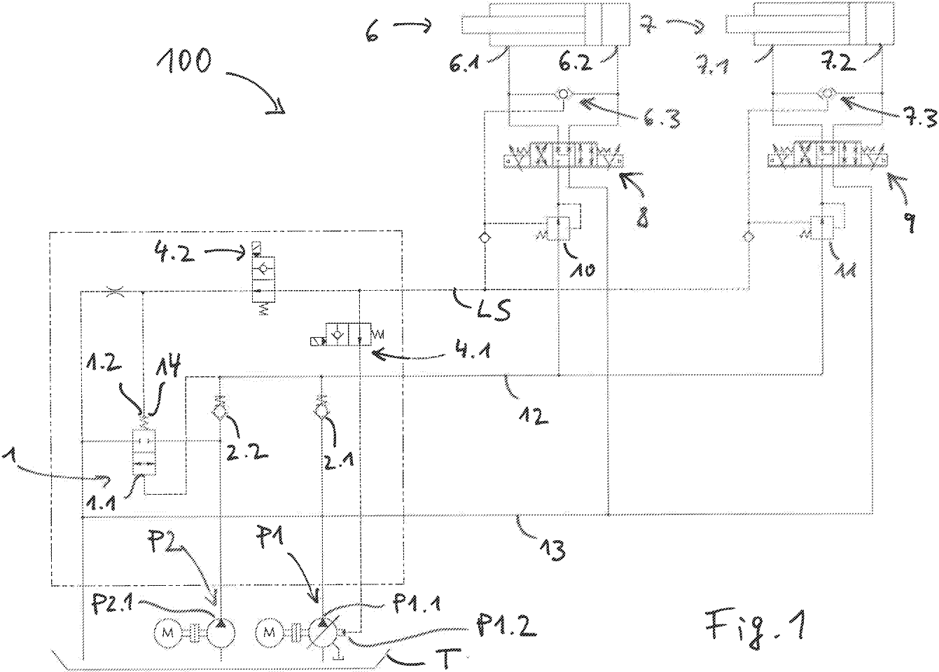

FIG. 1 shows an embodiment of a hydraulic system 100 including a first hydraulic actuator 6 and a second hydraulic actuator 7. Here, the hydraulic actuators 6, 7 each include a hydraulic cylinder with a movable piston. The hydraulic system 100 further includes two hydraulic pumps P1, P2 for delivering a hydraulic fluid such as oil to one or both of the actuators 6, 7 via their high-pressure ports P1.1, P2.1 which are fluidly connected or fluidly connectable to the actuators 6, 7 via a high-pressure fluid line 12. In the embodiment depicted here, the high-pressure ports P1.1, P2.1 of the hydraulic pumps P1, P2 are each fluidly connected or fluidly connectable to the high-pressure pressure fluid line 12 via a check valve 2.1, 2.2, respectively. Pressure reducing valves 10, 11 may be disposed between the hydraulic pumps P1, P2 and may provide a pressure drop between the pumps P1, P2 and the actuators 6, 7, respectively. It is understood that alternative embodiments of the hydraulic system 100 may not include the pressure reducing valves 10, 11. Further, the actuators 6, 7 are fluidly connected or fluidly connectable to a low-pressure tank T via a low-pressure fluid line 13.

The first hydraulic pump P1 is or includes a load sensing pump. That is, a hydraulic displacement of the first hydraulic pump P1 and, therefore, a flow rate supplied by the first hydraulic pump P1 is controllable via a hydraulic pressure applied to a load sensing port P1.2 of the first hydraulic pump P1. For instance, the first hydraulic pump P1 may include a movable swash plate, and the hydraulic pressure applied to the load sensing port P1.2 of the first hydraulic pump P1 may influence an inclination of the swash plate. The second pump may have a fixed hydraulic displacement.

The load sensing port P1.2 of the first hydraulic pump P1 is fluidly connected or fluidly connectable to a load sensing line LS, here via a first load sensing control valve 4.1. The first load sensing control valve 4.1 may be operated manually or via a controller. When the first load sensing control valve 4.1 is open, the load sensing port P1.2 of the first hydraulic pump P1 is fluidly connected with the load sensing line LS. And when the first load sensing control valve 4.1 is closed, the first hydraulic pump P1 does not receive a pressure signal at its load sensing port P1.2. In the latter case, the first hydraulic pump P1 may stop pumping or may continue to pump at zero or at near zero hydraulic displacement.

The load sensing line LS is fluidly connected or fluidly connectable to the fluid ports 6.1, 6.2 of the actuator 6 and to the fluid ports 7.1, 7.2 of the actuator 7 via shuttle valves 6.3, 7.3, respectively. In this manner, a load sensing hydraulic pressure in the load sensing line LS is equal to the maximum hydraulic pressure of the hydraulic pressures at the fluid ports 6.1, 6.2, 7.1, 7.2 of the actuators 6, 7. This maximum hydraulic pressure may be indicative of a load of one of the actuators 6, 7, for example. For instance, if the actuators 6, 7 are part of a lifting mechanism, the load of the actuators 6, 7 may correlate with a weight of a body supported on the actuators 6, 7.

The hydraulic system 100 further includes control valves 8, 9 configured to selectively fluidly connect the high-pressure fluid line 12 to each one of the actuators 6, 7, respectively. More specifically, the control valves 8, 9 selectively fluidly connect each of the high-pressure fluid line 12 and the low pressure line 13 to each one of the fluid ports 6.1, 6.2, 7.1, 7.2 of the hydraulic actuator 6, 7, respectively.

The hydraulic system 100 further includes a pressure controlled flow compensating valve 1. The flow compensating valve 1 selectively fluidly connects the high-pressure port P2.1 of the second hydraulic pump P2 to the low-pressure tank T.

A first piloting port 1.1 of the load compensating valve 1 is fluidly connected to at least one of the high-pressure ports P2.1, P1.1 of the hydraulic pumps P1, P2 via one or both of the check valves 2.2, 2.1. The flow compensating valve 1 is configured such that a hydraulic pressure applied to the piloting port 1.1 of the flow compensating valve 1 biases the flow compensating valve 1 to an open position in which the flow compensating valve 1 fluidly connects the high-pressure port P2.1 of the second hydraulic pump P2 to the low-pressure tank T.

A second piloting port 1.2 of the flow compensating valve 1 is fluidly connected or selectively fluidly connected to the load sensing line LS, here via a second load sensing control valve 4.2. The second load sensing control valve 4.2 is configured to selectively fluidly connect or fluidly disconnect the second piloting port 1.2 of the flow compensating valve 1 to or from the load sensing line LS. The flow compensating valve 1 is configured such that a hydraulic pressure applied to the second piloting port 1.2 of the flow compensating valve 1 via the load sensing line LS biases the flow compensating valve 1 to a closed position in which the flow compensating valve 1 fluidly disconnects the high-pressure port P2.1 of the second hydraulic pump P2 from the low-pressure tank T. Here, a biasing member 14 such as a spring additionally biases the flow compensating valve 1 to the closed position. It is understood that in alternative embodiments of the hydraulic system 100, the flow compensating valve 1 include a biasing member biasing the flow compensating valve 1 to the open position, or the flow compensating valve 1 may not include a biasing member.

When at a given instant the flow compensating valve 1 is closed and only the first hydraulic pump P1 provides flow and/or pressure to the actuators 6, 7 via the high-pressure line 12, an increase of a load acting on the actuators 6, 7 results in an increased hydraulic pressure in the load sensing line LS, and may further result in an increase of the hydraulic displacement of the first hydraulic pump P1 in case the first load sensing control valve 4.1 is open, thereby allowing the hydraulic pump P1 to supply fluid to the actuators 6, 7 at a higher rate. And when or once the hydraulic pressure in the load sensing line LS exceeds a threshold pressure and the second load sensing control valve 4.2 is open, the hydraulic pressure in the load sensing line LS causes the flow compensating valve 1 to close, thereby allowing the second hydraulic pump P2 to additionally supply flow and/or pressure to the actuators 6, 7.

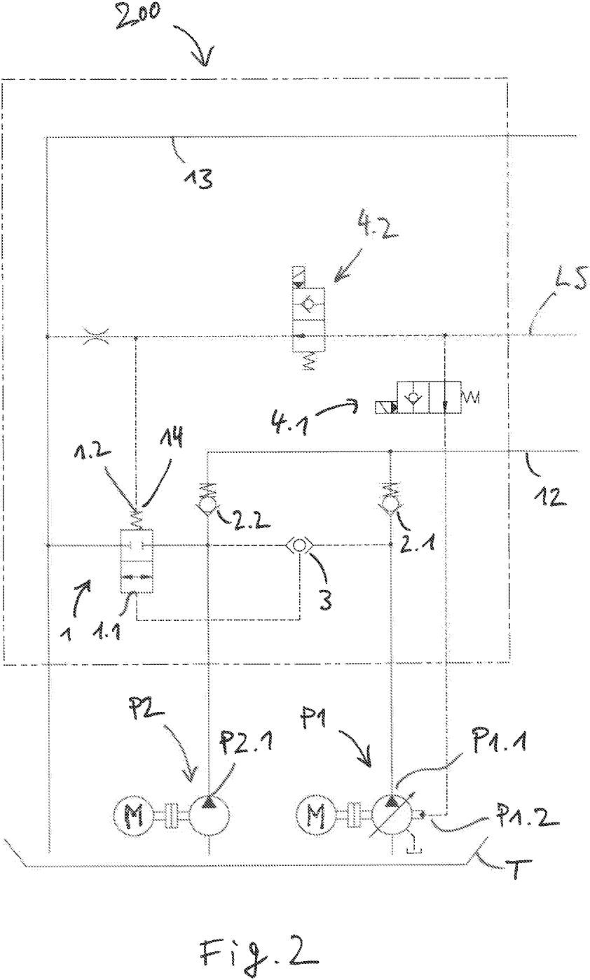

FIG. 2 shows a part of an embodiment of a hydraulic system 200 which is a variant of the hydraulic system 100 shown in FIG. 1. In FIGS. 1 and 2, recurring features are designated with the same reference signs. For brevity, only those features which distinguish the hydraulic system 200 of FIG. 2 from the hydraulic system 100 of FIG. 1 will be discussed in some detail. The remaining featurs of the hydraulic system 200 of FIG. 2 may be assumed to be configured in the same way as the correspondingly designated features of the hydraulic system 100 of FIG. 1.

In FIG. 2, the actuators 6, 7 and the control valves 8, 9 are not visible. FIG. 2 shows the two hydraulic pumps P1, P2, wherein the load sensing port P1.2 of the first hydraulic pump P1 is fluidly connectable or fluidly connected to the load sensing line LS in the same way as explained above with reference to FIG. 1. As in the hydraulic system 100 of FIG. 1, in the hydraulic system 200 of FIG. 2 the flow compensating valve 1 may selectively fluidly connect or disconnect the high-pressure port P2.1 of the second hydraulic pump P2 to and from the low-pressure tank T.

The hydraulic system 200 of FIG. 2 differs from the hydraulic system 100 of FIG. 1 in that in the hydraulic system 200 of FIG. 2 the first piloting port 1.1 of the flow compensating valve 1 is fluidly connectable to the high-pressure fluid ports P1.1, P2.1 of the hydraulic pumps P1, P2 via a shuttle valve 3. The shuttle valve 3 selects the maximum hydraulic pressure of the hydraulic pressures at the high-pressure fluid ports P1.1, P2.1 of the hydraulic pumps P1, P2 and applies said maximum hydraulic pressure at the first piloting port 1.1 of the flow compensating valve 1.

1. A hydraulic system, comprising:
a first hydraulic pump, a second hydraulic pump, at least one hydraulic actuator, a low-pressure tank, and a pressure controlled flow compensating valve,
wherein a high-pressure port of the first hydraulic pump and a high-pressure port of the second hydraulic pump are fluidly connected or fluidly connectable to the at least one hydraulic actuator,
wherein the high-pressure port of the second hydraulic pump is selectively fluidly connectable to the low-pressure tank via the flow compensating valve, and
wherein the flow compensating valve is controllable by or based on one or more of: a hydraulic pressure provided by the first hydraulic pump, a hydraulic pressure provided by the second hydraulic pump, and a hydraulic pressure at a fluid port of the at least one hydraulic actuator.

2. The hydraulic system of claim 1, wherein a first piloting port of the flow compensating valve is fluidly connected or fluidly connectable to the high-pressure port of the first hydraulic pump and/or to the high-pressure port of the second hydraulic pump.

3. The hydraulic system of claim 2, wherein the flow compensating valve is configured such that a hydraulic pressure applied to the first piloting port of the flow compensating valve biases the flow compensating valve to an open position in which the flow compensating valve fluidly connects the high-pressure port of the second hydraulic pump to the low-pressure tank.

4. The hydraulic system of claim 2, wherein the first piloting port of the flow compensating valve is fluidly connected or fluidly connectable to the high-pressure port of the first hydraulic pump and/or to the high-pressure port of second hydraulic pump via at least one check valve.

5. The hydraulic system of claim 2, wherein the first piloting port of the flow compensating valve is fluidly connected or fluidly connectable to the high-pressure ports of the first hydraulic pump and of the second hydraulic pump via a shuttle valve.

6. The hydraulic system of claim 1, wherein the first hydraulic pump is a load sensing pump and a hydraulic displacement of the first hydraulic pump is controllable via a hydraulic pressure applied to a load sensing port of the first hydraulic pump, wherein the load sensing port of the first hydraulic pump is fluidly connected or fluidly connectable to at least one fluid port of the at least one hydraulic actuator via a load sensing line.

7. The hydraulic system of claim 6, wherein the load sensing port of the first hydraulic pump is fluidly connected or fluidly connectable to the load sensing line via a first load sensing control valve.

8. The hydraulic system of claim 6, wherein the load sensing line is fluidly connectable to a first fluid port of the at least one hydraulic actuator and to a second fluid port of the at least one hydraulic actuator via a shuttle valve, the shuttle valve selecting a maximum hydraulic pressure between a hydraulic pressure at the first fluid port of the hydraulic actuator and a hydraulic pressure at the second fluid port of the hydraulic actuator.

9. The hydraulic system of claim 6, wherein a second piloting port of the flow compensating valve is fluidly connected or fluidly connectable to at least one fluid port of the at least one hydraulic actuator via the load sensing line.

10. The hydraulic system of claim 9, wherein the second piloting port of the flow compensating valve is selectively fluidly connectable to the load sensing line via a second load sensing control valve.

11. The hydraulic system of claim 9, wherein the flow compensating valve is configured such that a hydraulic pressure applied to the second piloting port of the flow compensating valve biases the flow compensating valve to a closed position in which the flow compensating valve fluidly disconnects the high-pressure port of the second hydraulic pump from the low-pressure tank.

12. The hydraulic system of claim 1, wherein the flow compensating valve includes a biasing member such as a spring biasing the flow compensating valve to a closed position in which the flow compensating valve fluidly disconnects the high-pressure port of the second hydraulic pump from the low-pressure tank.

13. The hydraulic system of claim 1, wherein the first hydraulic pump and the second hydraulic pump are fluidly connected or fluidly connectable to the at least one hydraulic actuator in parallel.

14. The hydraulic system of claim 6, further comprising a control valve, wherein the high-pressure port of the first hydraulic pump and the high-pressure port of the second hydraulic pump are selectively fluidly connectable to the at least one hydraulic actuator via the control valve.

15. The hydraulic system of claim 14, wherein the control valve is a directional control valve.

16. The hydraulic system of claim 14, wherein the load sensing line is fluidly connected to a fluid line which fluidly connects the control valve to the at least one hydraulic actuator.

17. The hydraulic system of claim 1, wherein the second hydraulic pump is a fixed displacement pump.
